(19) United States
(12) Patent Application Publication
(10) Pub. No.: US 2006/0238125 A1
(43) Pub. Date: Oct. 26, 2006

(54) Plasma display panel

(76) Inventors: Min Hur, Youngin-si (KR); Young-Do Choi, Youngin-si (KR)

Correspondence Address: Robert E. Bushnell, Suite 300, 1522 K Street, N.W., Washington, DC, 20005, US

(21) Appl. No.: 11/397,895

(22) Filed: Apr. 5, 2006

(30) Foreign Application Priority Data
Apr. 18, 2005 (KR) 10-2005-0032104

(51) Int. Cl. H01J 17/49

(52) U.S. Cl. 313/586; 313/582

(57) ABSTRACT

Disclosed is a plasma display panel. The plasma display panel includes an electrode structure in which an address electrode and a scan electrode generating an address discharge are aligned adjacent to each other such that an address voltage is constantly maintained at a relatively low level, thereby improving the light efficiency of the plasma display panel.

### CLAIM OF PRIORITY

This application makes reference to, incorporates the same herein, and claims all benefits accruing under 35 U.S.C. § 119 from an application earlier filed in the Korean Intellectual Property Office on the 18th of Apr. 2005 and there duly assigned Ser. No. 10-2005-0032104.

### BACKGROUND OF THE INVENTION

1. Technical Field

The present invention relates to a plasma display panel. More particularly, the present invention relates to a plasma display panel including an electrode structure in which an address electrode and a scan electrode generating an address discharge are aligned adjacent to each other such that an address voltage is constantly maintained at a relatively low level, thereby improving the light efficiency of the plasma display panel.

2. Description of the Prior Art

A plasma display panel refers to a panel used in a plasma display device, which is a kind of flat display devices, for realizing an image using a visible ray emitted from a fluorescent layer, when the fluorescent layer is excited by means of an ultraviolet ray generated from plasma, which is created when a gas discharge is performed with discharge gas being injected into a discharge space formed between two facing substrates. Such a plasma display panel can be classified into a DC type plasma display panel, an AC type plasma display panel, and an AC-DC type plasma display panel according to the structure and driving principle thereof. In addition, the plasma display panel can be classified into a surface discharge type plasma display panel and an opposed type plasma display panel according to the discharge structure thereof Recently, AC-type three-electrode surface discharge plasma panels have been extensively used.

A plasma display panel includes a front substrate, a rear substrate arranged opposite the front substrate, and an electrode required for the discharge operation.

The front substrate is a glass substrate having a thickness of about 2.8 mm, and being made from transparent soda glass such that a visible ray generated from a fluorescent layer may pass through the front substrate. A pair of X-Y electrodes are provided at a lower surface of the front substrate in order to generate a sustain discharge. Such a transparent electrode can be made from ITO (Indium Tin Oxide). A bus electrode is formed at a lower portion of the transparent electrode. The bus electrode has a width smaller than that of the transparent electrode and compensates for line resistance of the transparent electrode. The front substrate is provided at the lower surface thereof with a dielectric layer in order to cover transparent electrodes therein such that the transparent electrodes are prevented from being exposed outside. In addition, a passivation layer is formed on the dielectric layer in order to protect the dielectric layer.

The rear substrate is formed at an upper surface thereof with address electrodes in such a manner that the address electrodes cross the transparent electrodes formed on the lower surface of the front substrate. In addition, similar to the front substrate, the rear substrate is provided at the upper surface thereof with a dielectric layer in order to prevent the address electrodes formed on the upper surface of the rear substrate from being exposed outside. Barrier ribs are formed at the upper surface of the rear substrate so as to prevent electro-optical cross-talk from being produced between discharge cells while maintaining a discharge distance. The barrier ribs are provided between the front and rear substrates to form spaces for generating the plasma discharge and to define discharge cells, which are elements of a pixel serving as a basic unit for realizing an image displayed in a plasma display panel. Red, green or blue fluorescent layer is coated on both sidewalls of the barrier ribs forming the discharge cells and on an upper surface of the dielectric layer of the rear substrate in which the barrier ribs are not formed.

The plasma display panel having the above structure controls the number of sustain discharge operations according to video data transmitted thereto, thereby achieving a gray scale required for displaying an image. In order to achieve the gray scale, an ADS (address and display period separated) scheme is used, in which one frame is driven while being divided into a plurality of sub-fields having different numbers of discharge operations. According to the ADS scheme, each sub-field is divided into a reset period for uniformly generating the discharge, an address period for selecting a discharge cell, and a sustain and erasing period for expressing the gray scale according to the number of the discharge operations.

During the address period of the sub-field, an address discharge is generated due to a voltage difference between an address voltage applied to an address electrode aligned at a lower portion of a discharge cell selected to generate the discharge and a ground voltage applied to a scan electrode (Y electrode). In addition, when an address voltage with a polarity is applied to an address electrode aligned at the lower portion of the discharge cell selected to emit light, a ground voltage is applied to other address electrodes. Therefore, if a display data signal of the address voltage having the a polarity is applied to the address electrode while a ground voltage is being applied to a scan electrodes, a wall charge is formed in the corresponding discharge cells due to the address discharge, but the wall charge is not formed in other discharge cells. The sustain electrode (X electrode) is maintained with a predetermined voltage for effectively generating the address discharge during the address period. An optical efficiency, and choices of structures and materials for the display panel may depend on the magnitude of the address voltage required for the address discharge. As the magnitude of the address voltage increases, power consumption may increase, so that the optical efficiency is reduced, a sputtering effect is increasingly generated from the dielectric layers of the rear and front substrates, and the number of charged particles moving into adjacent discharge cells through the barrier ribs may increase (that is, the cross-talk may increase). Therefore, typically, it is advantageous if an address firing voltage is low.

However, in the three-electrode type surface discharge scheme, since a distance between the scan electrode and the address electrode is short, a relatively high discharge voltage is required. In addition, the discharge starts at an area in which a distance between two electrodes is shortest (that is, a center area of a discharge cell). After that, the discharge is generated at a peripheral area of the electrodes. That is, since a low firing voltage is applied to the center of the discharge cell, the discharge is generated in the center of the discharge cell. Once the discharge is generated, space charges are generated. Therefore, the discharge operation can be maintained with a predetermined voltage lower than the firing voltage, and the voltage applied between two electrodes gradually decreases with time. As the discharge operation starts, ions and electrons are accumulated in the center of the discharge cell so that strength of an electric field in the center of the discharge cell may become attenuated, and the discharge in the center of the discharge cell may vanish. Since the voltage applied between two electrodes decreases with time, a strong discharge may occur at the center of the discharge cell having a low light efficiency and a weak discharge may occur at the peripheral portion of the discharge cell having a high light efficiency. In this way, the plasma display panel employing the three-electrode type surface discharge scheme uses a relatively lower amount of input energy for heating electrons, so that the light efficiency of the plasma display panel may be degraded.

Recently, in order to solve the problem occurring in the plasma display panel employing the above three-electrode type surface discharge scheme, a plasma display panel employing an opposed discharge scheme has been developed. According to the opposed discharge scheme, an X electrode and a Y electrode are formed in barrier ribs facing each other in a space formed between a front substrate and a rear substrate, and address electrodes are aligned alternately with the X and Y electrodes. In the plasma display panel employing the opposed discharge scheme, a distance between a scan electrode and an address electrode is shorter than a distance between the scan electrode and the address electrode of the plasma display panel employing the surface discharge scheme, so that relatively lower address voltage is required. In addition, according to the opposed discharge scheme, the discharge is generated over the whole area of the discharge cell so that a discharge space is enlarged, thereby increasing the discharge efficiency. However, according to the opposed discharge scheme, the electrodes are formed in the barrier ribs, so the distance between barrier ribs, that is, the distance between electrodes for generating the discharge may vary according to the cell pitch so that the address voltage may also vary.

### SUMMARY OF THE INVENTION

Accordingly, the present invention has been made to solve one or more of the above-mentioned problems occurring in the plasma display panel employing an opposed discharge scheme, and an object of the claimed invention is to provide a plasma display panel including an electrode structure in which an address electrode and a scan electrode generating an address discharge are aligned adjacent to each other such that an address voltage is constantly maintained at a relatively low level, thereby improving the light efficiency of the plasma display panel.

In order to accomplish the above object, according to the present invention, there is provided a plasma display panel comprising: a first and a second substrates aligned facing each other; barrier ribs formed between the first and second substrates, and defining a plurality of discharge cells and including first barrier ribs aligned parallel to each other; first and second electrodes alternately formed between the first and the second substrates, the first barrier rib containing either the first electrode or the second electrode; a plurality of address electrodes aligned on an upper surface of the first substrate while crossing with the first and second electrodes; auxiliary address electrodes protruding from the address electrode, the auxiliary address electrodes extending from the address electrode toward the discharge cells, the auxiliary address electrodes cooperating with the first electrodes for generating an address discharge. The barrier ribs further comprise second barrier ribs aligned perpendicular to the first barrier ribs and formed at inner portions thereof with the address electrodes. The barrier ribs include dielectric layers.

According to the exemplary embodiment of the present invention, a fluorescent layer is formed on at least one of first and second substrates. The fluorescent layer includes a first fluorescent layer formed on a lower surface of the second substrate within the discharge cell and a second fluorescent layer formed at an upper surface of the first substrate within the discharge cell. The first and second electrodes include metal electrodes. In a vertical cross-sectional view, width of the first and second electrodes is smaller than height of the first and second electrodes.

The auxiliary address electrodes extend from the address electrodes in such a manner that the auxiliary electrode is spaced away from other address electrodes from which the auxiliary electrode does not protrude. In a vertical cross-sectional view, width of the auxiliary address electrode is larger than height of the auxiliary address electrode. When viewed from the top, the auxiliary address electrodes are arranged aside by a predetermined distance from the first electrodes. When again viewed from the top, the auxiliary address electrodes are arranged aside by a predetermined distance from the first barrier ribs containing the first electrodes. The predetermined distance is greater than or equal to zero. In a side view, the auxiliary address electrodes are arranged below the first electrodes. In addition, the auxiliary address electrodes are arranged closer to the first electrodes than the second electrodes.

According to the exemplary embodiment of the present invention, the auxiliary address electrodes are simultaneously formed in discharge cells, which are adjacent to each other and share the first electrodes. The auxiliary address electrodes are symmetrically aligned about the first electrodes.

The auxiliary address electrodes are formed at outer surfaces thereof with an auxiliary electrode dielectric layer. The auxiliary electrode dielectric layer is spaced away from other second barrier ribs containing other address electrodes from which the auxiliary electrode, on which the auxiliary electrode dielectric layer formed, does not protrude. Alternatively, the auxiliary electrode dielectric layer is connected to other second barrier ribs.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective view illustrating a plasma display panel constructed as a first embodiment of the present invention;

FIG. 2 is a horizontal sectional view taken along line A-A shown in FIG. 1;

FIG. 3 is a horizontal sectional view taken along line B-B shown in FIG. 1;

FIG. 4 is a vertical sectional view of a plasma display panel shown in FIG. 1; and

FIG. 5 is a horizontal sectional view of a plasma display panel constructed as a second embodiment of the present invention.

### DETAILED DESCRIPTION OF THE PREFERRED EMBODIMENTS

Hereinafter, embodiments of a plasma display panel according to the present invention will be described with reference to the accompanying drawings.

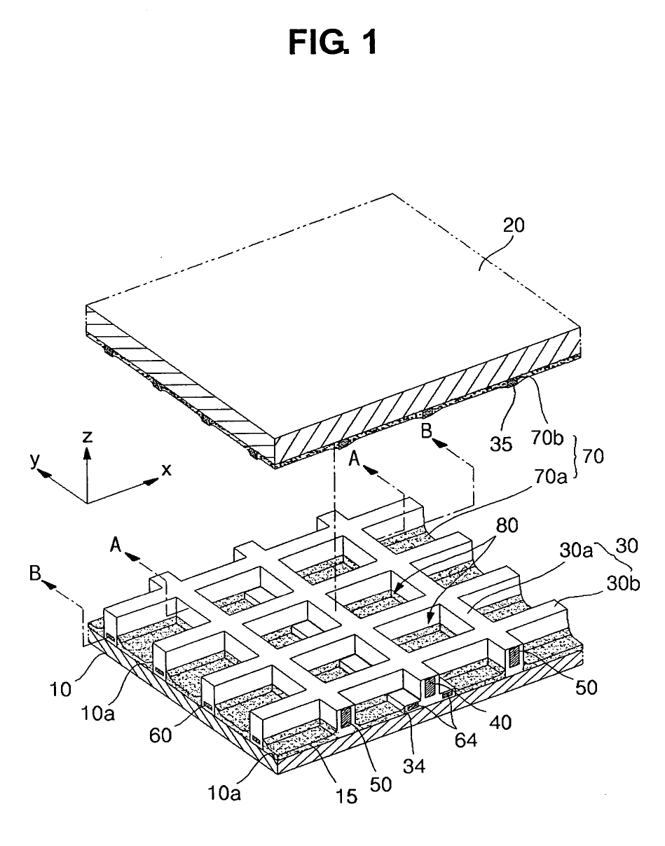

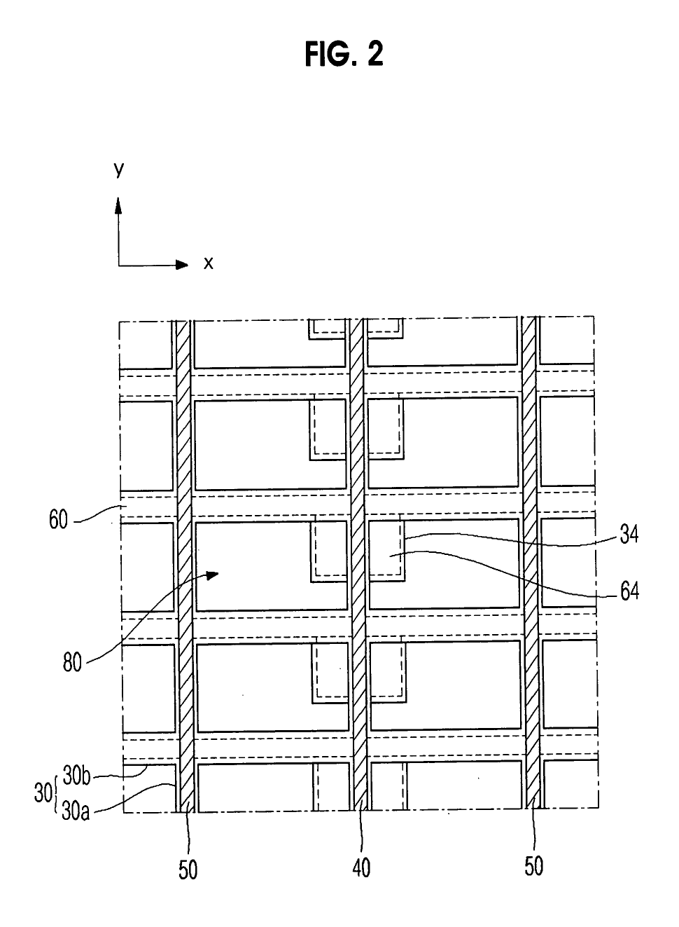

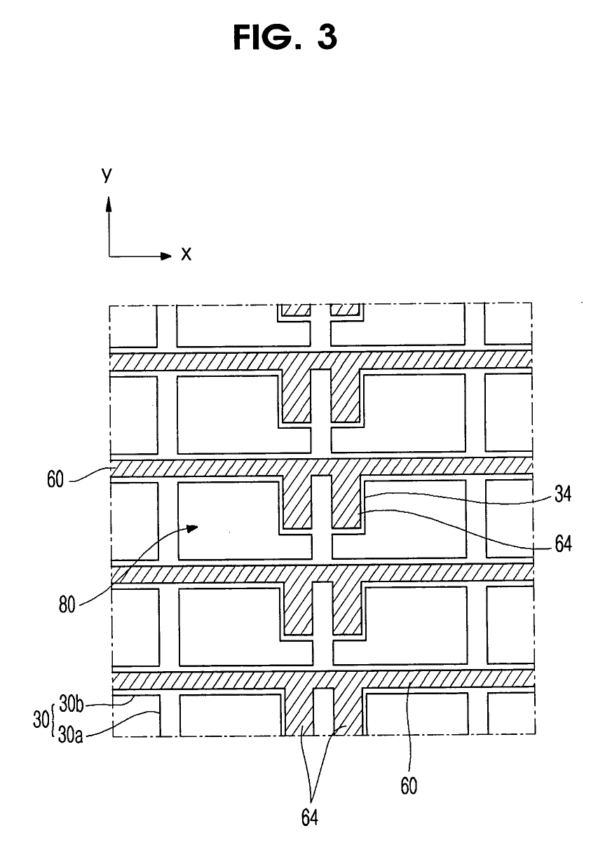

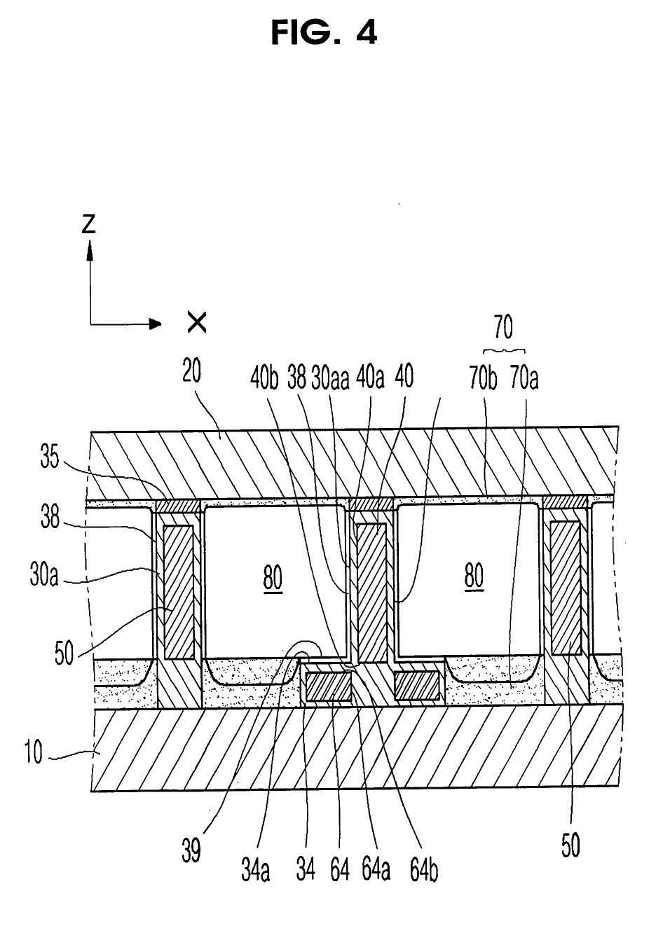

FIG. 1 is a partially exploded perspective view illustrating a plasma display panel according to a first embodiment of the present invention, FIG. 2 is a horizontal sectional view taken along line A-A shown in FIG. 1, FIG. 3 is a horizontal sectional view taken along line B-B shown in FIG. 1, and FIG. 4 is a vertical sectional view of the plasma display panel shown in FIG. 1.

Referring to FIGS. 1 to 4, the plasma display panel according to the first embodiment of the present invention includes a first substrate (hereinafter, referred to as a rear substrate) 10, a second substrate (hereinafter, referred to as a front substrate) 20, barrier ribs 30, first electrodes 40 and second electrodes 50. The rear substrate 10 and the front substrate 20 face each other while forming a predetermined interval therebetween, and a plurality of discharge cells 80 are defined by means of the barrier ribs 30 in a space formed between the rear substrate 10 and the front substrate 20. The discharge cell 80 includes a fluorescent layer 70 for absorbing an ultraviolet ray and discharging a visible ray. The discharge cell 80 is filled with discharge gas for generating the ultraviolet ray through the plasma discharge.

The rear substrate 10 is made from glass, and forms the plasma display panel together with the front substrate 20. The front substrate 20 is made from a transparent material, such as soda glass, and is placed facing the rear substrate 10. In addition, front barrier ribs 35 are formed at a lower surface of the front substrate 20 facing the rear substrate 10. In the following description, surfaces of elements facing the front substrate 20 along +z-axis in FIG. 1 are referred to as “upper surfaces” and surfaces of elements facing the rear substrate 10 along -z-axis in FIG. 1 are referred to as “lower surfaces”.

The barrier ribs 30 include first barrier ribs 30a aligned parallel to each other in one direction (along y-axis in FIG. 1), and second barrier ribs 30b aligned perpendicular to the first barrier ribs 30a (along x-axis in FIG. 1). In addition, a space, surrounded by the barrier ribs 30 together with the rear substrate 10 and the front substrate 20, is defined as a discharge cell 80, where the discharge is generated. The first barrier ribs 30a include either the first electrode 40 or the second electrode 50, which are alternately arranged on a space between the rear substrate 10 and the front substrate 20. In addition, the second barrier ribs 30b are provided at inner portions thereof with address electrodes 60.

The barrier ribs 30 are made from glass substances including components, such as lead, boron, silicon, aluminum, and oxygen. Preferably, the barrier rib 30 is formed by using a dielectric substance including a filler such as zirconium dioxide (ZrO₂), titanium dioxide (TiO₂), or aluminum oxide (Al₂O₃), and a pigment such as chromium, copper, cobalt, or iron. However, the present invention does not limit materials for the barrier ribs 30, and the barrier ribs 30 can be formed using various dielectric substances. The barrier ribs 30 facilitate the discharge of the electrodes formed therein while preventing the electrodes from being damaged due to collisions of charged particles, which are accelerated during the discharge operation.

Preferably, magnesium oxide (MgO) protective layers 38 are formed at sidewalls of the barrier ribs 30 corresponding to the first and second electrodes 40 and 50. The magnesium oxide (MgO) protective layer 38 (shown in FIG. 4) is made from a material including magnesium oxide (MgO) used for protecting the dielectric substance in the plasma display panels. The magnesium oxide (MgO) protective layer 38 prevents the electrodes from being damaged during the discharge operation, and emits secondary electrons to lower the discharge voltage. The magnesium oxide (MgO) protective layer 38 is a thin film formed through a sputtering scheme or an E-beam evaporation scheme.

The front barrier ribs 35 have shapes and heights that are designed to be matched to those of horizontal sections of the barrier ribs 30, and formed at the lower surface of the front substrate 20, that is, between the barrier ribs 30 and the front substrate 20. Accordingly, when the rear substrate 10 is coupled with the front substrate 20, the front barrier ribs 35 may be matched with the barrier ribs 30, thereby defining the discharge cells 80. Therefore, the front barrier ribs 35 allow a fluorescent layer 70 to have a predetermined thickness, when the fluorescent layer 70 is formed on the lower surface of the front substrate 20. At the same time, the front barrier ribs 35 prevent a fluorescent layer, which is being coated on a discharge cell, from being coated on other adjacent discharge cells 80, because the adjacent discharge cells 80 may require fluorescent layers of different colors. However, it is also possible that a plasma display panel of the present invention may not have the front barrier ribs 35, if the fluorescent layer 70 can be formed on the lower surface of the front substrate 20 with the predetermined thickness, and the fluorescent layers having different colors can be separately coated on each of the discharge cells 80 without the front barrier ribs 35. The front barrier ribs 35 can be integrally formed on the front substrate 20 by etching the front substrate 20, or can be separately formed on the front substrate 20 with different materials. Similar to the barrier ribs 30, the front barrier ribs 35 can be formed using dielectric substances. In this case, magnesium oxide (MgO) protective layers are formed at outer surfaces of the front barrier ribs 35.

The first and second electrodes 40 and 50 are formed parallel to the first barrier ribs 30a of the barrier ribs 30, and alternately arranged about the discharge cells 80, so that the first electrode 40 or the second electrode 50 is commonly shared by two nearby discharge cells 80. In addition, the first and second electrodes 40 and 50 are formed inside the first barrier ribs 30a. Preferably, the positions of the first and second electrodes 40 and 50 are biased upwards (along +z-axis in FIG. 1) as shown in FIG. 4. Accordingly, the first electrode 40 is placed on one side of the discharge cell 80, and the second electrode 50 is placed on the opposite side of the discharge cell 80, so that the discharge operation may be achieved by means of pairs of the first and second electrodes 40 and 50. In addition, preferably, in a cross-sectional view (a view along y-axis) of the first and second electrodes 40 and 50 as shown in FIG. 4, width of the first and second electrodes 40 and 50 (a length of the electrodes along x-axis) are smaller than heights of the first and second electrodes 40 and 50 (a length of the electrodes along z-axis). Thus, the first and second electrodes 40 and 50, which are located at each side of the discharge cell 80, may generate a discharge in a relatively large area, thereby producing a strong ultraviolet ray. The strong ultraviolet ray may stimulate the fluorescent layer 70 over a relatively large area of the discharge cells 80, thereby increasing an amount of visible light being produced from the fluorescent layer 70. In addition, the first electrodes 40 may generate the address discharge through an opposed discharge scheme together with the address electrodes 60 so that the address discharge can be efficiently performed. Hereinafter, the first electrodes are referred to as “scan electrodes” for generating the address discharge in cooperation with the address electrodes, and the second electrodes 50 as “sustain electrodes”. Although the first electrode 40 is set as the scan electrode and the second electrode 50 is set as the sustain electrode, it is also possible to set the first electrode 40 as the sustain electrode and to set the second electrode 50 as the scan electrode.

Since the first and second electrodes 40 and 50 are disposed in the first barrier ribs 30a, it is not necessary for the first and second electrodes 40 and 50 to have transparent characteristics. Thus, the first and second electrodes 40 and 50 can be provided in the form of metal electrodes made from conductive metals. Preferably, the first and second electrodes 40 and 50 are made from metals having superior conductivity and low resistance, such as silver, aluminum or copper. In this case, the first and second electrodes 40 and 50 may have the fast response speed against the discharge while preventing signal distortion and reducing power consumption required for the sustain discharge. Materials for the first and second electrodes 40 and 50, however, are not limited in the present invention, if the materials have characteristics of superior conductivity and low resistance.

The address electrodes 60 are formed inside the second barrier ribs 30b, and are aligned parallel to the second barrier ribs 30b. The address electrode 60 is positioned at a lower portion of the second barrier rib 30b biased downwards (along −z-axis in FIG. 1) so that the address electrodes 60 are disposed at both sides of the discharge cells 80 parallel to the discharge cells 80. In addition, an address electrode 60 has auxiliary address electrodes 64 that protrude from the address electrode, and extend toward the discharge cells 80 from the address electrodes 60 in order to generate an address discharge together with the first electrodes 40 (refer to FIG. 2).

The auxiliary address electrodes 64 are formed between the first and second electrodes 40 and 50, and are connected to an address electrode 60. The auxiliary address electrodes 64 extend toward inner portions of the discharge cells 80 from the address electrodes 60. In particular, the auxiliary address electrodes 64 are adjacent to the first electrodes 40 that serve as scan electrodes. Accordingly, an address discharge is generated between first electrodes 40 and address electrodes 60 through auxiliary address electrodes 64. In addition, the auxiliary address electrodes 64 are positioned closer to the first electrodes 40 than the second electrodes 50. In other words, a distance between the first electrode 40 and the auxiliary address electrode 64 is shorter than a distance between the second electrode 50 and the auxiliary address electrode 64. Thus, the address discharge is generated between the auxiliary address electrodes 64 and the first electrodes 40. In addition, one auxiliary address electrode 64 is provided in one discharge cell 80. As shown in FIG. 2, discharge cells 80 are formed at both sides of a first electrode 40, commonly sharing the first electrode 40, and an auxiliary address electrode 64 is provided for each of the discharge cells 80. Preferably, the auxiliary address electrodes 64 formed at both sides of the first electrode 40 are symmetrically arranged about the first electrodes 40, having the same distance between the auxiliary address electrode 64 and the first electrode 40. A uniform address discharge can be obtained due to the symmetric arrangement of the auxiliary address electrodes 64

In a cross-sectional view (a view along y-axis) of the auxiliary address electrode 64 as shown in FIG. 4, width of the auxiliary address electrode 64 (a length of the electrode along x-axis) is larger than height of the auxiliary address electrode 64 (a length of the electrode along z-axis). Accordingly, the auxiliary address electrodes 64 can generate the address discharge together with the first electrodes 40 over a relatively large area through an opposed discharge scheme.

The auxiliary address electrodes 64 extending from an address electrode 60 are spaced away from other address electrodes, which are located at the opposite sides of the discharge cells 80, by a predetermined distance. Thus, there is no electrical connection between an address electrodes 60 and other address electrodes located at opposite sides of the discharge cells 80.

The outer surfaces of the auxiliary address electrode 64 are formed with an insulating layer. Preferably, an auxiliary electrode dielectric layer 34 made from dielectric substance is formed on the outer surfaces of the auxiliary address electrode 64 with a predetermined thickness. The auxiliary electrode dielectric layer 34 covers the whole area of the auxiliary address electrode 64. In addition, the auxiliary electrode dielectric layer 34 is preferably made from a material identical to that of the barrier rib 30, and can be integrally formed with the barrier rib 30. The auxiliary electrode dielectric layer 34 is spaced away from other second barrier ribs 30b, which are located at the opposite sides of the discharge cells 80, by a predetermined distance. Therefore, the auxiliary electrode dielectric layer 34 may not cover the entire area of the discharge cell 80 so that the fluorescent layer can be formed over a relatively large area of the upper surface of the rear substrate 10, thereby improving light efficiency.

Preferably, the outer surface of the auxiliary electrode dielectric layer 34 is formed with an magnesium oxide (MgO) protective layer 39 for protecting the dielectric layer. The magnesium oxide (MgO) protective layer 39 prevents the auxiliary electrodes 64 from being damaged during the discharge operation, and emits secondary electrons to lower the discharge voltage. The magnesium oxide (MgO) protective layer 39 is a thin film formed through a sputtering scheme or an E-beam evaporation scheme.

Referring to FIG. 4, regarding positions along x-axis, a position of the lateral portion 64a of the auxiliary address electrode 64 is spaced away from a position of the lateral portion 40a of the first electrode 40 by a predetermined distance, or is matched with a position of the lateral portions 40a of the first electrodes 40. That is, upper surfaces 64b of the auxiliary address electrodes 64 may not directly face the lower surfaces 40b of the first electrodes 40. Accordingly, the address discharge is generated in a relatively large area defined by the upper surfaces 64b of the auxiliary address electrodes 64 and the lateral portions 40a of the first electrodes 40 through the opposed discharge scheme so that the address discharge can be effectively performed.

In addition, regarding positions along z-axis, the level of the upper surfaces 64b of the auxiliary address electrodes 64 is identical to or lower than the level of the lower surfaces 40b of the first electrodes 40. The auxiliary address electrodes 64 may not interfere with the sustain discharge generated between the first and second electrodes 40 and 50, so that the sustain discharge can be stably performed. Preferably, the level of an upper surface 34a of the auxiliary electrode dielectric layer 34 formed on the upper surfaces 64b of the auxiliary address electrodes 64 may not exceed the level of the lower surfaces 40b of the first electrodes 40. That is, the level of the auxiliary electrode dielectric layer 34 is equal to or lower than the level of the lower surfaces 40b of the first electrodes 40. Accordingly, the first electrodes 40 allow the wall charges to be accumulated on a relatively large area of lateral portions 30aa of the first barrier ribs 30a during the address discharge operation, so that the address discharge can be effectively performed.

In addition, again regarding positions along x-axis, the auxiliary address electrodes 64 are aligned in such a manner that a position of the lateral portions 64a of the auxiliary address electrodes 64 is matched with a position of the lateral portions 30aa of the first barrier ribs 30a. Accordingly, the auxiliary address electrodes 64 allow the wall charges to be accumulated on a relatively large area, so that the address discharge can be effectively performed.

The fluorescent layer 70 can be formed on at least one of the rear substrate 10 and front substrate 20 within the discharge cells 80, and absorbs an ultraviolet rays so as to generate visible rays. Preferably, the fluorescent layer 70 includes a first fluorescent layer 70a formed on the surface of the rear substrate 10 in the discharge cells 80 and a second fluorescent layer 70b formed on the surface of the front substrate 20 in the discharge cells 80. Thus, the first fluorescent layer 70a formed on the surface of the rear substrate 10 absorbs ultraviolet rays, generates visible rays, and reflects the visible rays toward the front substrate 20. Accordingly, the first fluorescent layer 70a is a reflective fluorescent layer. The second fluorescent layer 70b formed on the surface of the front substrate 20 absorbs ultraviolet rays, generates visible rays, and allows the visible rays to pass through the front substrate 20. In addition, the visible rays reflected from the first fluorescent layer 70a also pass through the second fluorescent layer 70b. Thus, in order to improve transmittance of the visible rays passing through the front substrate 20, the thickness of the second fluorescent layer 70b, which is a transmissive fluorescent layer, is preferably smaller than the thickness of the first fluorescent layer 70a, which is a reflective fluorescent layer. Since the transmittance of the visible ray at the second fluorescent layer 70b is substantially proportional to the thickness of the fluorescent layer, the thickness of the second fluorescent layer 70b is properly selected by considering the light efficiency of the discharge cells 80. In addition, the thickness of the first fluorescent layer 70a is also properly selected by considering the light efficiency of the discharge cells 80. In the meantime, the electrode structure employing the opposed discharge scheme may not have another electrodes over an entire surface of the discharge cell 80, but may have the second fluorescent layer 70b over the entire surface of the discharge cell 80, so the transmittance of the visible ray and the discharge efficiency can be improved as compared with those of the electrode structure employing the surface discharge scheme.

The fluorescent layer 70 has components capable of generating the visible rays by receiving the ultraviolet rays. A red fluorescent layer formed on a red light emitting discharge cell may include a fluorescent substance, such as Y (V,P)O₄ : Eu, a green fluorescent layer formed on a green light emitting discharge cell may include a fluorescent substance, such as Zn₂SiO₄: Mn, and a blue fluorescent layer formed on a blue light emitting discharge cell may include a fluorescent substance, such as BAM: Eu. That is, the fluorescent layer is divided into red, green and blue light emitting fluorescent layers and formed in adjacent discharge cells 80. The adjacent discharge cells 80 formed with the red, green and blue light emitting fluorescent layers form a unit pixel, and the visible rays transmitted from the adjacent discharge cells 80 are combined for realizing a color image.

The discharge cells 80 are defined by means of the rear substrate 10, the barrier ribs 30 and the front substrate 20. The discharge cells 80 are filled with discharge gas (e.g., a mixture of gases including xenon, neon, etc) in order to generate the plasma discharge. In addition, the fluorescent layer 70 for generating the visible rays by receiving ultraviolet rays is provided in the discharge cells 80 corresponding to an upper surface area of the rear substrate 10 and predetermined portions of the barrier ribs 30. That is, the fluorescent layer 70 is coated on the barrier ribs 30 and the upper surface of the rear substrate 10 corresponding to the height of the first and second electrodes 40 and 50. The width and length of the discharge cells 80 may vary depending on light efficiency of each fluorescent substance.

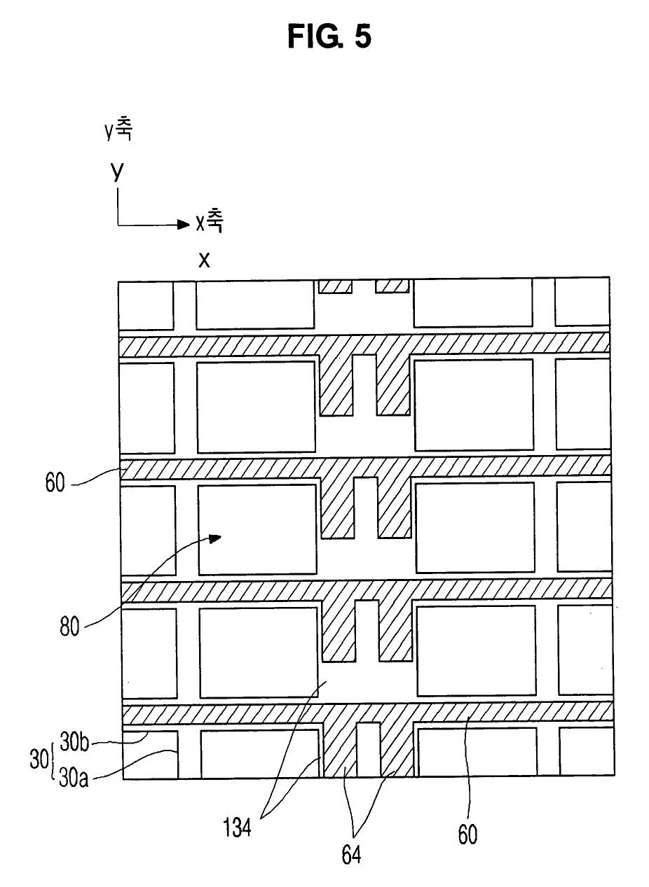

Hereinafter, the plasma display panel according to a second embodiment of the present invention will be described. FIG. 5 is a horizontal sectional view of the plasma display panel according to the second embodiment of the present invention. The plasma display panel according to the second embodiment of the present invention is substantially similar to the plasma display panel according to the first embodiment of the present invention shown in FIGS. 1 to 4. Thus, the following description will be focused on different parts therebetween in order to avoid redundancy.

Referring to FIG. 5, in the plasma display panel according to the second embodiment of the present invention, an auxiliary electrode dielectric layer 134 surrounds the auxiliary address electrodes 64. In addition, the auxiliary electrode dielectric layer 134 is connected to other second barrier ribs 30b, which are located opposite the second barrier ribs 30b about the discharge cells 80. That is, the auxiliary electrode dielectric layer 134 is formed over the whole area of one side of the discharge cell 80. Thus, the internal structure of the discharge cell 80 may be simplified as compared with that of the discharge cell 80 shown in FIG. 1 so that the auxiliary electrode dielectric layer 134 can be easily formed. Since the auxiliary electrode dielectric layer 134 is an insulating layer, the auxiliary address electrodes 64 can be electrically disconnected from the other address electrodes 60, which are located opposite the auxiliary address electrodes 64 about the discharge cells 80.

Hereinafter, the description will be made in relation to the discharge operation of the plasma display panel according to the present invention.

The discharge operation of the plasma display panel is sequentially performed in the order of reset discharge, address discharge and sustain discharge. The following description will be focused on the address discharge and the sustain discharge.

The address discharge is performed by applying the address voltage between the address electrodes 60 formed on the second barrier ribs 30b and the first electrodes 40 serving as the scan electrodes. In detail, the address discharge is generated between the first electrodes 40 and the auxiliary address electrodes 64 that extend from the address electrodes 60 towards the discharge cells 80, and are disposed between the first and second electrodes 40 and 50, thereby addressing the discharge cells 80 in which the sustain discharge is performed. At this time, since the distance between the first electrodes 40 and the auxiliary address electrodes 64 is very short, it is possible to perform the address discharge by applying a low address voltage. In addition, the distance between the first electrodes 40 and the auxiliary address electrodes 64 can be maintained as a constant regardless of the distance between first and second electrodes 40 and 50 and pitch of discharge cells, so that the address voltage can be maintained at the low level. Since the address discharge is performed with a low address voltage, strength of the electric field formed in the discharge cells by means of the electric potential applied to the first electrodes 40 and the auxiliary address electrodes 64 may increase, and charged particles generated in the discharge cells 80 are accelerated such that the charged particles have relatively high energy. Thus, the address discharge can be easily performed. That is, according to the plasma display panel employing the opposed discharge scheme, the strength of the electric field formed in the discharge cells 80 can be increase, so that it is possible to reduce the electric potential applied to the address electrodes 60 for the desired address discharge. Therefore, it is possible to reduce the cost of IC chips that is used to control an electric signal applied to the address electrodes 60, resulting in the reduction of the manufacturing cost for the plasma display panel. In the meantime, the first electrodes 40 are shared by two discharge cells 80 adjacent to each other along x-axis, and the address electrodes 60 are shared by the discharge cells 80 adjacent to each other along y-axis. Thus, the address discharge can be simultaneously performed in the two discharge cells 80 adjacent to each other along x-axis.

The sustain discharge is performed by applying a predetermined sustain voltage to the first and second electrodes 40 and 50, which are formed at each side of the addressed discharge cells 80 facing each other. At this time, the first electrodes 40 are shared by adjacent discharge cells 80, and the second electrodes 50 are aligned facing the first electrodes 40 across the discharge cells 80. Accordingly, the sustain discharge is performed by applying the sustain voltage to the first and second electrodes 40 and 50, which face each other across the discharge cell 80 where the sustain discharge is generated. The sustain discharge is performed in only one discharge cell 80 that is located between the first and second electrodes 40 and 50. In addition, because the auxiliary address electrodes 64 are provided below the first and second electrodes 40 and 50, the auxiliary address electrodes 64 may not interfere with the first and second electrodes 40 and 50 during the sustain discharge operation. The sustain discharge is performed through an opposed discharge scheme between the first and second electrodes 40 and 50 which face each other and maintain a large gap therebetween across the discharge cell 80, the discharge efficiency and discharge uniformity can be improved. In addition, the sustain discharge can be simultaneously performed in two adjacent discharge cells 80 by applying the sustain voltage to both of the second electrodes 50 that are formed on the opposite sides of the adjacent discharge cells 80 that commonly shares the first electrode 40. Therefore, the sustain discharge can be more efficiently performed.

As described above, according to the plasma display panel of the present invention, the auxiliary address electrodes are aligned adjacent to the scan electrodes, so the address discharge can be performed with relatively low address voltage.

In addition, according to the present invention, it is possible to maintain a constant distance between the auxiliary address electrodes and the scan electrodes generating the address discharge, regardless of a design of discharge cells 80. Therefore, the address voltage can be maintained as the same, even if the distance between the scan electrodes and the sustain electrodes is changed.

According to the present invention, the electrodes generating the address discharge and the sustain discharge are aligned in the barrier ribs of the rear substrate, so the fluorescent layer can be formed in the front substrate, improving the light efficiency of the plasma display panel.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A plasma display panel comprising:
a first and a second substrates aligned facing each other;
barrier ribs formed between the first and the second substrates, the barrier ribs defining a plurality of discharge cells and comprising first barrier ribs;
first and second electrodes alternately formed between the first and the second substrates, the first barrier rib containing either the first electrode or the second electrode;
address electrodes formed on an inner surface of the first substrate, the address electrodes crossing the first and second electrodes; and
auxiliary address electrodes protruding from the address electrode, the auxiliary address electrodes extending from the address electrode toward the discharge cells, the auxiliary address electrodes cooperating with the first electrodes for generating an address discharge.

2. The plasma display panel as claimed in claim 1, the barrier ribs further comprising second barrier ribs aligned perpendicular to the first barrier ribs, the second barrier ribs containing the address electrodes.

3. The plasma display panel as claimed in claim 2, wherein the barrier ribs include dielectric layers.

4. The plasma display panel as claimed in claim 1, further comprising a fluorescent layer formed on at least one of the first and the second substrates.

5. The plasma display panel as claimed in claim 1, further comprising a fluorescent layer including a first fluorescent layer formed on an inner surface of the second substrate within the discharge cell and a second fluorescent layer formed on an inner surface of the first substrate within the discharge cell.

6. The plasma display panel as claimed in claim 1, wherein the first and second electrodes include metal electrodes.

7. The plasma display panel as claimed in claim 1, wherein width of the first and second electrodes is smaller than height of the first and second electrodes.

8. The plasma display panel as claimed in claim 1, the auxiliary addrress electrode being spaced away from other address electrodes from which the auxiliary electrode does not protrude.

9. The plasma display panel as claimed in claim 1, wherein width of the auxiliary address electrode is larger than height of the auxiliary address electrode.

10. The plasma display panel as claimed in claim 1, the auxiliary address electrodes being arranged aside on a plane parallel to the first substrate by a predetermined distance from the first electrodes.

11. The plasma display panel as claimed in claim 10, the auxiliary address electrodes being arranged aside on a plane parallel to the first substrate by a predetermined distance from the first barrier ribs containing the first electrodes, the predetermined distance being greater than zero or equal to zero.

12. The plasma display panel as claimed in claim 1, the auxiliary address electrodes being arranged below the first electrodes.

13. The plasma display panel as claimed in claim 1, the auxiliary address electrodes being arranged closer to the first electrodes than the second electrodes.

14. The plasma display panel as claimed in claim 1, wherein the auxiliary address electrodes are formed in discharge cells, which are adjacent to each other to share the first electrodes.

15. The plasma display panel as claimed in claim 14, wherein the auxiliary address electrodes are symmetrically aligned about the first electrodes.

16. The plasma display panel as claimed in claim 2, further comprising an auxiliary electrode dielectric layer formed on outer surfaces of the auxiliary address electrodes.

17. The plasma display panel as claimed in claim 16, the auxiliary electrode dielectric layer being spaced away from other second barrier ribs containing other address electrodes from which the auxiliary electrode, on which the auxiliary electrode dielectric layer formed, does not protrude.

18. The plasma display panel as claimed in claim 16, the auxiliary electrode dielectric layer being connected to other second barrier ribs.
